(19) United States
(12) Patent Application Publication
(10) Pub. No.: US 2025/0233377 A1
(43) Pub. Date: Jul. 17, 2025

(54) Plug with Temperature-Controlled Circuit Breaker

(71) Applicant: AuOne Electronic Manufacturing Limited, Foshan (CN)

(72) Inventors: Chi Man Ao, Foshan (CN); Ka Seng Ao, Foshan (CN); Hehua Li, Foshan (CN); Ziheng Chen, Foshan (CN)

(73) Assignee: AuOne Electronic Manufacturing Limited, Foshan (CN)

(21) Appl. No.: 19/087,383

(22) Filed: Mar. 21, 2025

Related U.S. Application Data
(63) Continuation-in-part of application No. 18/783,349, filed on Jul. 24, 2024.

(30) Foreign Application Priority Data
Jan. 11, 2024 (CN) 2024100391827

(51) Int. Cl. H01R 13/713; H01R 24/30; H01R 103/00

(52) U.S. Cl. CPC H01R 13/7137; H01R 24/30; H01R 2103/00

(57) ABSTRACT

A plug with a temperature-controlled circuit breaker can include a main body; a lead end; a first pin; and a second pin; wherein the lead end is fixed on a first end of the main body, wherein the first pin and the second pin are provided on a second end of the main body, wherein an overheat/overcurrent protection component is connected in series between the lead end and the first pin, and wherein the second pin is connected to the lead end, and wherein the second pin is thermally connected to, and electrically insulated from, the overheat/overcurrent protection component.

### CROSS-REFERENCE TO RELATED APPLICATIONS

This application is a continuation-in-part of application Ser. No. 18/783,349, filed on Jul. 24, 2024, which claims the benefit of priority of Chinese Patent Application No. 2024100391827, filed Jan. 11, 2024, both of which are incorporated herein by reference.

### TECHNICAL FIELD

The present disclosure relates to the technical field of electrical plugs, more particularly to a plug with a temperature-controlled circuit breaker.

### BACKGROUND

At present, common electrical power cord plugs available on the market are manufactured by directly connecting two pins to a power cord (that is, a live wire and a neutral wire) and then molding by injection of PVC. A power plug includes pins, a support, and a lead. Each pin has one end connected to one end of the lead within the support, while another end of the lead is exposed out of the support for insertion into a power socket to interface with a power supply, where the power supply is fed to an electrical appliance through the lead. The support is configured to insulate each pin and insulate electrified parts from the outside world. To guarantee the safety of electricity usage, generally, power supply circuits and electrical appliances are provided with overload and short circuit protection mechanisms therein. Once a short circuit occurs, a main fuse of the power supply circuit will trip, or an internal protection circuit inside the electrical appliance will short circuit, which could affect other electrical appliances, and disrupt everyday work and life.

At present, common three-phase plugs have two specifications for ground wire pins. One is in a cylindrical shape and one is in a flat sheet shape, which are not interchangeable. Multiple plugs need to be carried during usage because each plug is made to only one specification. Particularly, for present plugs, when a lead end and a shell are assembled through a connection structure, an adhesive is further needed to adhere them together. If a plug is damaged, it can only be discarded rather than repaired, resulting in a waste of resources. Further, the plug and the socket can easily loosen from each other after a period of usage leading to poor contact, and can burn out the plug and the socket.

Therefore, the existing technology needs to be improved and further developed.

### SUMMARY

In view of the shortcomings and deficiencies of the existing technologies, the present disclosure aims to provide a plug with a temperature-controlled circuit breaker which is reasonably structured, widely compatible, and safe to use.

In order to achieve the above aim, the present disclosure employs the following technical embodiments.

A plug with a temperature-controlled circuit breaker can include a main body; a lead end; a first pin; and a second pin; wherein the lead end is fixed on a first end of the main body, wherein the first pin and the second pin are provided on a second end of the main body, wherein an overheat/overcurrent protection component is connected in series between the lead end and the first pin, and wherein the second pin is connected to the lead end, and wherein the second pin is thermally connected to, and electrically insulated from, the overheat/overcurrent protection component.

A plug with temperature-controlled circuit breaker can include an overheat/overcurrent protection component further comprising a connecting terminal; a fixed contact piece; a bimetallic strip; wherein the connecting terminal is fixedly connected to the fixed contact piece by an insulated terminal, and a static contact is arranged on the connecting terminal, wherein the bimetallic strip has a first end fixedly connected to the fixed contact piece and the bimetallic strip has a second end provided with a moving contact, and wherein a first pin is fixedly connected to the fixed contact piece and a lead end is connected to the connecting terminal of the overheat/overcurrent component.

A plug with temperature-controlled circuit breaker can include a second pin and an overheat/overcurrent protection component sandwiching a heat conductor, which thermally connects, and electrically isolates, the second pin and the overheat/overcurrent protection component, and wherein the heat conductor is an electrically-insulated, thermal conductor comprising a ceramic material.

A plug with temperature-controlled circuit breaker can include a second pin comprising a fin, and wherein a heat conductor is sandwiched between the fin of the second pin and an overheat/overcurrent protection component.

A plug with temperature-controlled circuit breaker can include a positive temperature coefficient (“PTC”) element bridging a connecting terminal and a bimetallic strip.

A plug with temperature-controlled circuit breaker can include a moving contact welded onto a bimetallic strip with a molten material, or a static contact is welded onto a connecting terminal with a molten material.

A plug with temperature-controlled circuit breaker an include a main body further comprising a ground wire pin, and wherein the ground wire pin is electrically connected to a lead end.

A plug with temperature-controlled circuit breaker can include one or both of a first pin or aa second pin further comprising at least one fin, wherein the at least one fin provides increased surface area for one or more of physical, electrical, or thermal connection.

A plug with temperature-controlled circuit breaker can include a first pin which is a live wire pin and a second pin which is a neutral wire pin.

A plug with temperature-controlled circuit breaker can include an overheat/overcurrent protection component which disconnects a first lead end and a first pin when either the first pin or a second pin reaches a predetermined temperature.

A plug with temperature-controlled circuit breaker can include a main body further comprising a housing; wherein the housing is a hollow structure with an upper opening and plug holes on a lower surface, wherein located within the housing is a cover comprising upper protrusions and two constituent components which are arranged symmetrically, and are removably connected to each other to form an aperture, and wherein located within the housing is a frame comprising lower protrusions and plug holes, wherein a lead end comprises a neck groove, wherein the neck groove is removably connected to the aperture such that the lead end is removably connected to the upper opening of the housing, and wherein a first pin and a pin insert through the plug holes of the frame and the housing.

A plug with temperature-controlled circuit breaker can include a main body further comprising a ground wire pin, wherein the ground wire pin is electrically connected to a lead end, and wherein the ground wire pin inserts through plug holes of a frame and a housing.

A plug with temperature-controlled circuit breaker can include an overheat/overcurrent protection component further comprising an automatic reset.

A plug with a temperature-controlled circuit breaker can include a main body; a lead end comprising a neck groove; a live wire pin; a neutral wire pin; an overcurrent/overheat protection component; wherein the overheat/overcurrent protection component is connected in series between the lead end and the live wire pin, wherein the neutral wire pin is thermally connected to, but electrically insulated from, the overheat/overcurrent protection component, and wherein the lead end is connected to the neutral wire pin.

A plug with temperature-controlled circuit breaker can include an overheat/overcurrent protection component connected in series between a lead end and a live wire pin at a first live fin and a second live fin, wherein the lead end is connected to a neutral wire pin at a first neutral fin, and wherein a second neutral fin of the neutral wire pin is thermally connected to, but electrically insulated from, the overheat/overcurrent protection component.

A plug with temperature-controlled circuit breaker can include a shell and a positioning module, wherein the positioning module comprises at least two constituent components combined by removeable connection, and comprises a plurality of limit blocks.

A plug with temperature-controlled circuit breaker can include a shell, wherein the shell comprises plug holes on a lower end surface of the shell, and wherein a live wire pin and a neutral wire pin insert through the plug holes of the shell.

A plug with temperature-controlled circuit breaker can include a shell and a positioning module, wherein the shell is a hollow structure with an upper opening, wherein the positioning module defines a positioning opening, and the positioning module fits within the upper opening of the shell, wherein a neck groove is removably connected to the positioning opening of the positioning module such that a lead end is removably connected to the upper opening of the shell.

A plug with temperature-controlled circuit breaker can include a shell; a positioning module; a ground wire pin; a first locking structure; a second locking structure; an assistant pairing structure; and an assistant assembly structure; wherein the ground wire pin is provided on a second end of a main body, and wherein a lead end is connected to the ground wire pin, wherein the first locking structure and the second locking structure retain the ground wire pin, wherein the first locking structure and the second locking structure release the ground wire pin when the ground wire pin is rotated and slid upward, wherein the assistant pairing structure couples the positioning module with the lead end, wherein the assistant pairing structure releases the positioning module from the lead end when a tool is applied, wherein the assistant assembly structure couples the positioning module with the shell, and wherein the assistant assembly structure releases the positioning module from the shell when a sufficiently large vertical force is applied to the positioning module or the shell.

A plug with a temperature-controlled circuit breaker can include a main body; a lead end; a live wire pin; and a neutral wire pin; wherein the lead end is fixed on a first end of the main body, wherein the live wire pin and the neutral wire pin are provided on a second end of the main body, wherein the live wire pin comprises a first live fin and a second live fin, wherein the neutral wire pin comprises a first neutral fin and a second neutral fin, wherein an overheat/overcurrent protection component is connected in series between the lead end and the live wire pin via the first live fin, wherein the second live fin is thermally connected to the overheat/overcurrent protection component, wherein the first neutral fin is connected to the lead end, and wherein the second neutral fin is thermally connected to, and electrically insulated from, the overheat/overcurrent protection component.

The present disclosure has a number of possible beneficial effects. The present disclosure is reasonable in structure. Inside the plug main body is an overheat/overcurrent protection component which, when poor contact, short circuit, and the like occur in a circuit resulting in overheat and overcurrent between the plug and a socket, the component automatically cuts off the circuit between the lead end and the pin, preventing the plug and the socket from burning out and avoids impacting other electrical appliances.

### BRIEF DESCRIPTION OF THE DRAWINGS

FIG. 1 is a structural diagram of the present disclosure with shell removed.

FIG. 2 is a structural diagram of the present disclosure in a state of disassembly.

FIG. 3 is a structural diagram of a ground wire pin assembled with a limit block according to the present disclosure.

FIG. 4 is a detailed structural diagram of part A shown in FIG. 3.

FIG. 5 is a detailed structural diagram of part B shown in FIG. 3.

FIG. 6 is a structural diagram of a ground wire pin and a quick replacement component according to the present disclosure.

FIG. 7 is a structural diagram of a lead end assembled with a positioning module according to the present disclosure.

FIG. 8 is a detailed structural diagram of part C shown in FIG. 7.

FIG. 9 is a detailed structural diagram of part D shown in FIG. 7.

FIG. 10 is a detailed structural diagram of part E shown in FIG. 7.

FIG. 11 is a structural diagram of an alternate embodiment of the present disclosure with housing removed.

FIG. 12A and FIG. 12B are alternate views of an alternate embodiment of the present disclosure with housing removed.

FIG. 13A and FIG. 13B are structural diagrams of an alternate embodiment of the present disclosure in a state of disassembly from alternate views.

### DETAILED DESCRIPTION OF THE EMBODIMENTS

The technical scheme of the present disclosure is described below in conjunction with the drawings and embodiments.

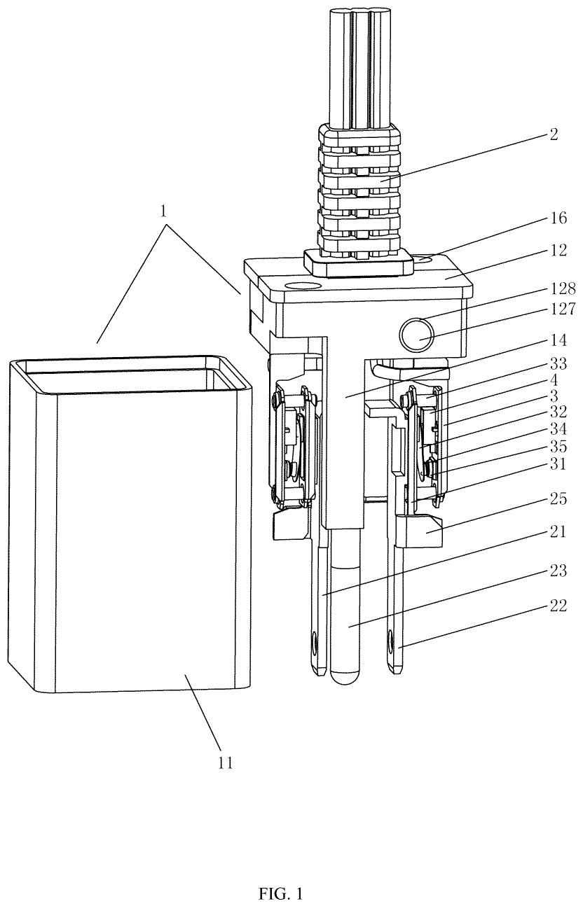

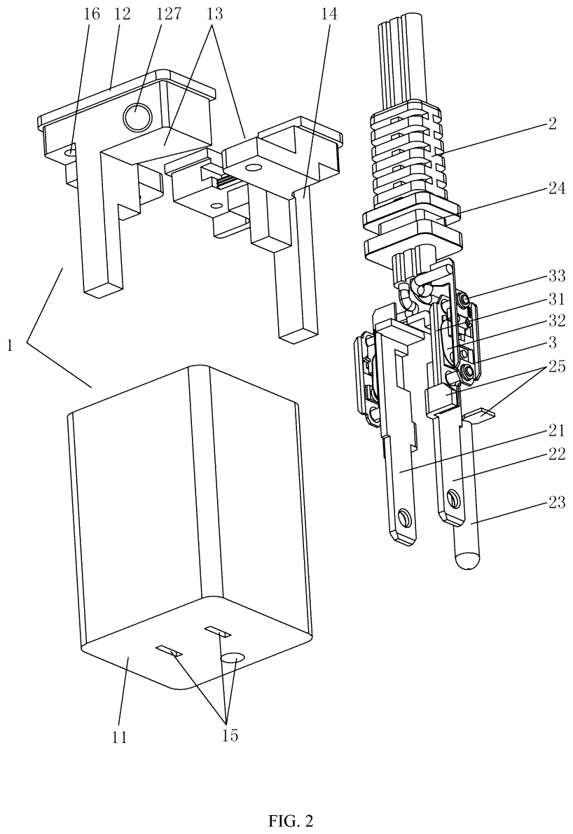

As illustrated in FIG. 1 to FIG. 2, the plug with temperature-controlled circuit breaker according to the present disclosure includes a main body 1 and a lead end 2. The lead end 2 is fixed on a first end of the main body 1. A second end of the main body 1 is provided with a live wire pin 21 and a neutral wire pin 22. The main body 1 can further be provided with a ground wire pin 23. Between the lead end 2 and the live wire pin 21 and/or between the lead end 2 and the neutral wire pin 22 are/is connected in series to overheat/overcurrent protection component(s). The overheat/overcurrent protection component is positioned in the main body 1 to connect the lead end 2 with the live wire pin 21 or the neutral wire pin 22 in series. When the plug main body 1 is inserted into a power supply socket for an electrical appliance, if poor contact, load short, or the like occur between the plug and the socket, resulting in excessive current and over temperature, the overheat/overcurrent protection component can respond in time and cut off the current path on the live wire pin 21 or the neutral wire pin 22, thereby preventing the plug main body 1 and the socket from burning out. Furthermore, only after plug main body 1 powers off and any issues are resolved, can the overheat/overcurrent protection component be reset and repowered, thereby avoiding frequent disconnection of the power supply which can otherwise render other electrical appliance unusable, and can adversely impact daily life.

The overheat/overcurrent protection component includes a connecting terminal 3, a fixed contact piece 31, and a bimetallic strip 32. The connecting terminal 3 is fixedly connected to the fixed contact piece 31 by an insulated terminal 33. The bimetallic strip 32 has a first end fixedly connected to the fixed contact piece 31. The bimetallic strip 32 has a second end provided with a moving contact 34, and a static contact 35 is arranged on the connecting terminal 3. The live wire pin 21 and the neutral wire pin 22 are each fixedly connected to corresponding fixed contact pieces 31. A live wire and a neutral wire at the lead end 2 can each be connected to connecting terminals 3 of two overheat components respectively. The live wire at the lead end 2 is welded to the connecting terminal 3, forming a series connection with the live wire pin 21 by using the overheat/overcurrent protection component. Similarly, the neutral wire at the lead end 2 is welded to the connecting terminal 3, forming a series connection with the neutral wire pin 22 by using the overheat/overcurrent protection component. Once an electrical overload or short circuit occurs on the circuit between an electrical appliance, the plug, and a socket, particularly when poor contact and the like occur between the plug and the socket, or when an electrical spark, temperature rise, or the like occur at the contact area between the plug and the socket during use of the electrical appliance, the bimetallic strip 32 can respond quickly and deform, cutting off the path between the moving contact 34 and the static contact 35, thereby disconnecting the current flow to protect the plug main body 1 and the socket. Preferably, two sets of overheat/overcurrent protection components are arranged inside the plug main body 1, providing dual protection and improving safety.

A positive temperature coefficient (“PTC”) element 4 is bridged between the connecting terminal 3 and the bimetallic strip 32. The PTC element 4 has a far greater value of resistance than the bimetallic strip 32. In normal conditions, the PTC element 4 and the bimetallic strip 32 are equivalent to being in parallel connection, and the PTC element 4 does not activate due to a very low division voltage, hence does not generate heat. When poor contact results in high temperature and short circuit, the bimetallic strip 32 trips to cut off the path between the moving contact 34 and the static contact 35, enabling the PTC element 4 to receive a working voltage, and the PTC element 4 generates heat to maintain the thermal deformation state of the bimetallic strip 32. Therefore, the plug main body 1 needs to power off to reduce the temperature of the PTC element 4 before it can be reused, thereby implementing a power-off reset function and avoiding power supply circuit trips caused by an electrical appliance restarting before electrical issues can be resolved.

The moving contact 34 is welded onto the bimetallic strip 32 employing a molten material, or the static contact 35 is welded onto the connecting terminal 3 employing a molten material. The molten material can achieve a fusing effect. When the overheat/overcurrent protection component has a failure, the molten material on the moving contact 34 or the static contact 35 also fails, thereby causing the moving contact 34 and the static contact 35 to disengage and forcing the power off, protecting the socket, the electrical appliance, and the whole power supply circuit.

The main body 1 includes a shell 11 and at least one positioning module 12. The shell 11 is a hollow structure with an upper opening. Inside the upper opening of the shell 11 is provided positioning module 12, and the positioning module 12 comprises at least two constituent components which are removably connected, such as by snap-fitting. The constituent components are arranged symmetrically such that positioning module 12 forms a positioning opening 13. The lead end 2 defines a neck groove 24. The neck groove 24 is removably connected to the positioning opening 13, whereby the lead end 2 is fixed toward the upper opening of the shell 11. The shell 11 employs injection molding processes and has insulating properties, and is used to assemble the internal overheat/overcurrent protection component and circuit. The lead end 2 is first welded with the connecting terminal 3. The lead end 2 is positioned within the positioning module 12, which is placed about the neck groove 24. The shell 11 defines plug holes 15 on a lower end surface. The live wire pin 21, the neutral wire pin 22, and the ground wire pin 23 are aligned with plug holes 15 on shell 11, and then are installed through the upper opening of the shell 11. The positioning module 12 defines a fixing hole 16, and the positioning module 12 can be fixedly connected to the shell 11 by a fastener, such as a bolt, and the fixing hole 16, thereby allowing quick assembly.

The positioning module 12 is provided with a plurality of limit blocks 14. The live wire pin 21, the neutral wire pin 22, and the ground wire pin 23 are each provided with a folding plate 25. The shell 11 defines plug holes 15 on a lower end surface thereof. The live wire pin 21, the neutral wire pin 22, and the ground wire pin 23 insert through corresponding plug holes 15. The limit blocks 14 on the positioning module 12 are connected to and abut against the folding plates 25 on the live wire pin 21, the neutral wire pin 22, and the ground wire pin 23 respectively. The limit blocks 14 abut against the folding plates 25, limiting any movement of live wire pin 21, the neutral wire pin 22, and the ground wire pin 23 within shell 11, preventing any loosening of the pins, increasing the stability of the overheat/overcurrent protection components and prolonging the service life of the product.

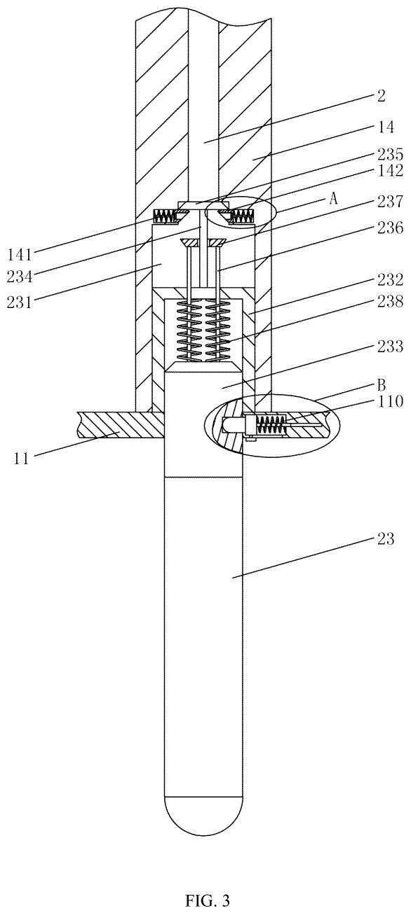

As illustrated in FIG. 3, the limit block 14 paired with the ground wire pin 23 defines thereon an assembly groove 231, a ground wire at the lead end 2 is embedded into the limit block 14 and extends into the assembly groove 231, and the ground wire pin 23 has an upper end provided with a quick replacement component. The quick replacement component comprises a conductive sleeve 232 and a conductive pole 233. The conductive pole 233 is fixedly connected to the upper end of the ground wire pin 23, and the conductive pole 233 is slidably inserted into the conductive sleeve 232. The conductive sleeve 232 has an upper end plate with a conductive pin 234. The conductive pin 234 has an upper end with a second disc 235. The conductive sleeve 232 is slidably inserted into the assembly groove 231, whereby the second disc 235 contacts and is electrically connected to the ground wire. The assembly groove 231 is provided at least one first locking structure. A slide rod 236 passes through the upper end plate of the conductive sleeve 232. The slide rod 236 has a lower end fixedly connected to the conductive pole 233; and the slide rod 236 has an upper end provided with a first disc 237. The first disc and the second disc are positioned about the first locking structure, below and above the first locking structure respectively. Inside the conductive sleeve 232 is a first spring 238, and the first spring 238 abuts against the upper end plate of the conductive sleeve 232 and an upper end surface of the conductive pole 233. The ground wire pin 23 can be removed and replaced by using the quick replacement component. The conductive sleeve 232 and the conductive pole 233 are assembled on the ground wire pin 23, and a corresponding limit block 14 defines thereupon an assembly groove 231. When the ground wire pin 23 is being assembled, the second disc 235 is inserted into the assembly groove 231, and the first locking structure locks the second disc 235, whereby the second disc 235 is electrically connected to and abuts against the ground wire at the lead end 2. The second disc 235, the conductive pin 234, the conductive sleeve 232, the conductive pole 233, and the ground wire pin 23 are connected in sequence to form part of a ground circuit.

To remove the ground wire pin 23, the ground wire pin 23 is pushed upward along a vertical direction, wherein the conductive pole 233 drives the first disc 237 upward via the slide rod 236, and the first disc 237 squeezes against the first locking structure to unlock the same, thereafter the second disc 235 can slide from the assembly groove 231, and the ground wire pin 23 can be removed from the limit block 14.

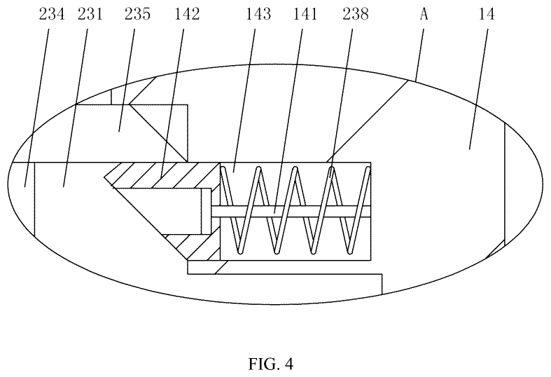

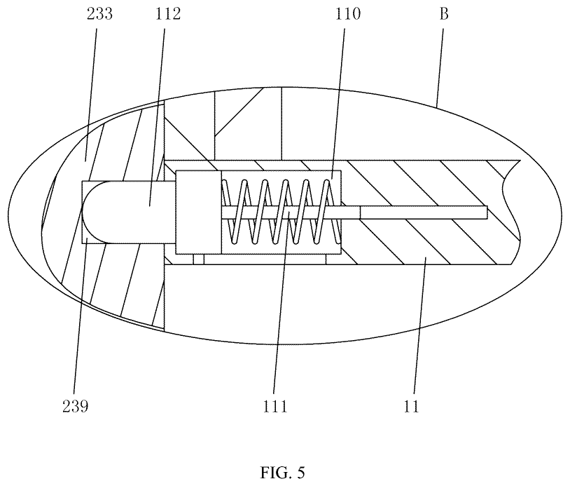

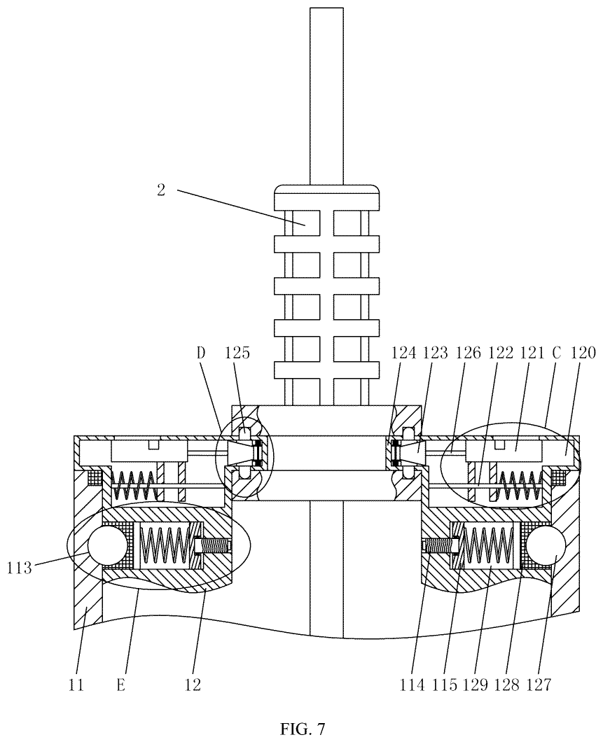

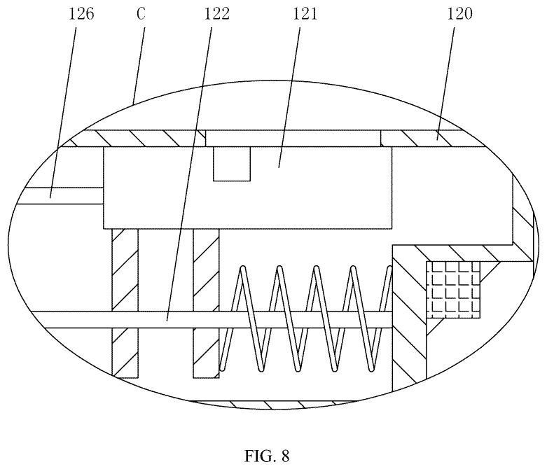

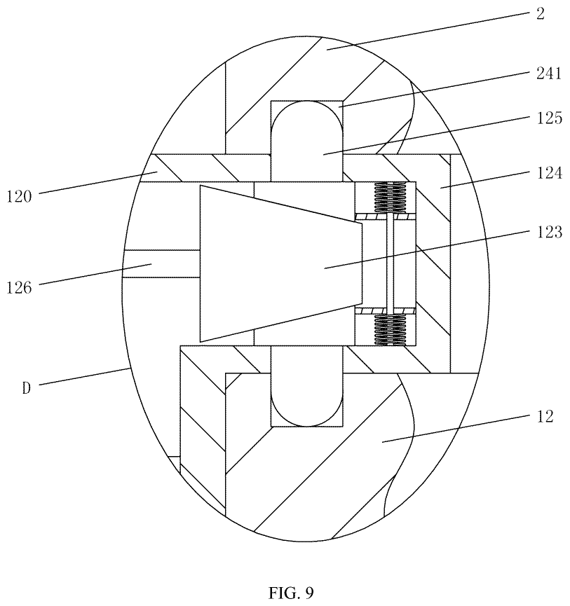

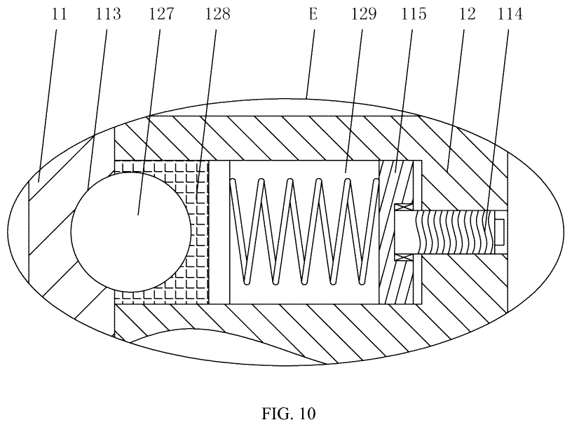

As illustrated in FIG. 3 to FIG. 10, specifically, the plug can include at least one first locking structure including a first guide rod 141 and a slope limit seat 142. The inner walls of the two sides of the assembly groove 231 each define a first chute 143. Inside the first chute 143 is provided the first guide rod 141 and an elastic element. The first guide rod 141 has a first end fixedly connected to the assembly groove 231. The slope limit seat 142 is slidably arranged on a second end of the first guide rod 141. The elastic element abuts against the slope limit seat 142, whereby the slope limit seat 142 is removably connected to the first disc 237. The slope limit seat 142 can move transversely along the first guide rod 141. The elastic element can be a spring. The elastic element drives the slope limit seat 142 toward the conductive pin 234. When assembled, the slope limit seat 142 abuts against the second disc 235 to lock the same. When the conductive pole 233 drives the first disc 237 to move upward, the first disc 237 pushes against a slope of the slope limit seat 142 and generates a transverse squeeze force to overcome the force of the elastic element, whereby the slope limit seat 142 retracts into the first chute 143 to unlock the second disc 235.

At least one second locking structure is located between the ground wire pin 23 and the shell 11. The second locking structure includes a second chute 110, a second guide rod 111, and a columnar locking tab 112. The second chute 110 is arranged within the shell 11 and adjacent to the conductive pole 233. The conductive pole 233 defines a first locking groove 239 connected to the second chute 110. Inside the second chute 110 is the second guide rod 111 and an elastic element. The second guide rod 111 has a first end fixedly connected to the second chute 110. The columnar locking tab 112 is slidably arranged on a second end of the second guide rod 111. The elastic element abuts against the columnar locking tab 112, whereby the columnar locking tab 112 is removably connected to the first locking groove 239. Preferably, the conductive pin 234 penetrates through the first disc 237, and the conductive pin 234 is rotatable relative to the conductive sleeve 232. In this way, the ground wire pin 23 can be removed by rotating the ground wire pin 23 so that the conductive pole 233 presses against the columnar locking tab 112, subjecting the columnar locking tab 112 to a pressure and columnar locking tab 112 thereby slides from the first locking groove 239 to retract into the second chute 110, allowing the second locking structure to unlock the ground wire pin 23. Thereafter, the ground wire pin 23 can slide upward to unlock the first locking structure.

At least one assistant pairing structure is arranged between the positioning module 12 and the lead end 2 and couples the positioning module 12 to the lead end 2. The assistant pairing structure includes a lock box 120 containing a driving slider 121, a third guide rod 122, and a wedged driving head 123. The lock box 120 is arranged adjacent to an upper end of the positioning module 12. The third guide rod 122 is fixedly arranged inside the lock box 120. The driving slider 121 is slidably connected to the third guide rod 122, and the lock box 120 has an upper end surface defining a maintenance opening. Inside the neck groove 24 is defined a second locking groove 241. One end of the lock box 120 is provided with a locking head 124. The locking head 124 is inserted into neck groove 24 in a removably connected state, and the locking head 124 is provided with an elastic fastener 125. The wedged driving head 123 is fixedly connected to the driving slider 121 by a synchronous connecting rod 126. Inside the lock box 120 is positioned an elastic element, and the elastic element abuts against the driving slider 121, whereby the elastic fastener 125 is fitted about the wedged driving head 123. The assistant pairing structure is used for quick assembly of the positioning module 12 and the lead end 2. The positioning module 12 clamps the lead end 2, and the neck groove 24 removably connects with the positioning opening 13. The locking head 124 on the lock box 120 is inserted into the neck groove 24. The elastic element drives the wedged driving head 123 to press against the elastic fastener 125, whereby the elastic fastener 125 is removably connected into the second locking groove 241, such that the positioning module 12 and the lead end 2 are quickly connected for convenient assembly into the shell 11. Of course, when a part inside the shell 11 needs repair, as the driving slider 121 has defined thereon a depression corresponding to the maintenance opening of lock box 120, a small tool can be used to engage the depression via the maintenance opening to separate the positioning module 12 from the lead end 2 by pushing the driving slider 121 away from the locking head 124, whereby the synchronous connecting rod 126 drives the wedged driving head 123 away from the elastic fastener 125. Thereafter, the elastic fastener 125 can be reset and disengaged from the second locking groove 241, allowing the positioning module 12 to separate from the lead end 2.

At least one assistant assembly structure is arranged between the positioning module 12 and the shell 11. The assistant assembly structure includes a steel ball 127, a rubber block 128, and an elastic element in a third locking groove 129 defined within the positioning module 12. The third locking groove 129 has a first end extending through an outer wall of the positioning module 12 to form an opening. The shell 11 has an inner wall, and defined thereon is a limit recess 113. The rubber block 128 and the steel ball 127 are inserted into the opening of the first end of the third locking groove 129. Inside the third locking groove 129 is provided an elastic element, and the elastic element drives the rubber block 128 and the steel ball 127 toward the limit recess 113. The positioning module 12 and the lead end 2 form an integrated structure which is then inserted into the upper opening of the shell 11, whereby the steel ball 127 is paired with the limit recess 113, the elastic element drives an outer end of the rubber block 128 against an inner wall of the shell 11, and the steel ball 127 is clamped into the limit recess 113, such that the vertical positioning is locked between the positioning module 12 and the shell 11 and the manner of locking is resilient. When a sufficiently large vertical force is applied to the positioning module 12 or the shell 1, the vertical force can overcome the force of the elastic element, disengaging the steel ball 127 from the limit recess 113, thereby facilitating subsequent disassembly and maintenance of the positioning module and the shell.

The third locking groove 129 has a second end provided with an adjusting screw 114 which can modify the vertical force required to disengage the steel ball 127, and thus the force required to disengage the positioning module 12 and the shell 11 from each other. The adjusting screw 114 is in threaded connection with the third locking groove 129. Inside the third locking groove 129 is an adjusting press plate 115. The adjusting screw 114 has one end connected to the adjusting press plate 115. The elastic element is arranged between the adjusting press plate 115 and the rubber block 128. Further, a friction force between the rubber block 128 and the shell 11 as well as a fit strength between the steel ball 127 and the limit recess 113 can be modified by the adjusting screw 114. The adjusting screw 114 can be rotated to drive the adjusting press plate 115 toward or away from the steel ball 127, thereby changing the force of the elastic element. It is understood that the elastic element is a spring.

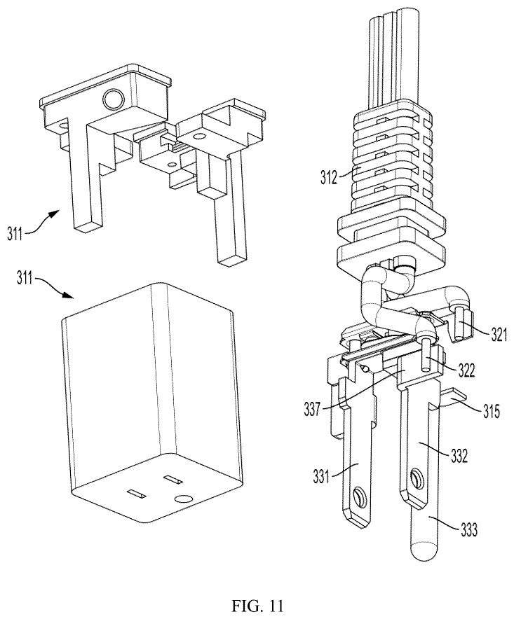

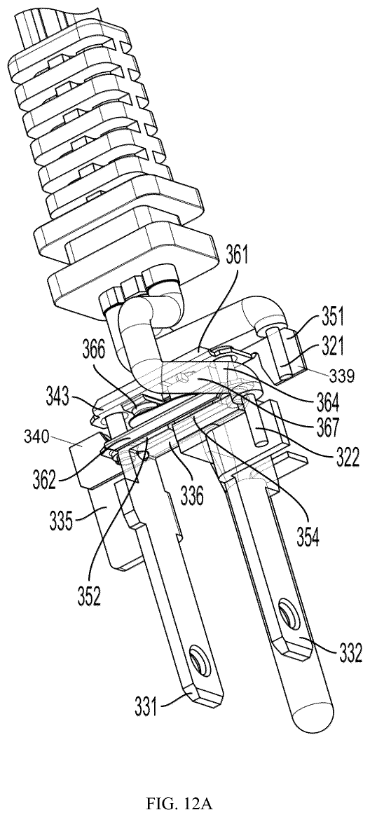

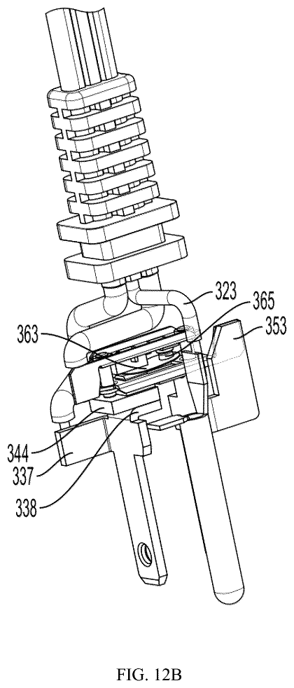

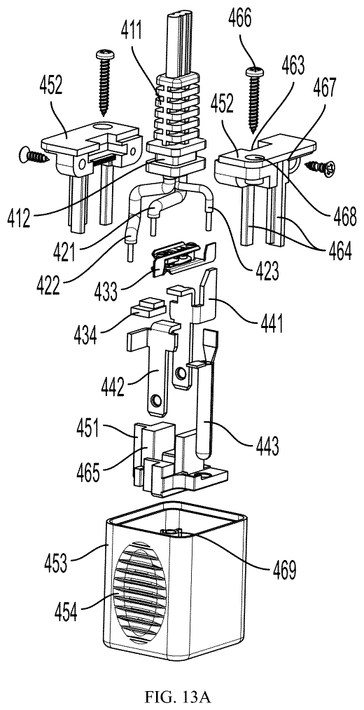

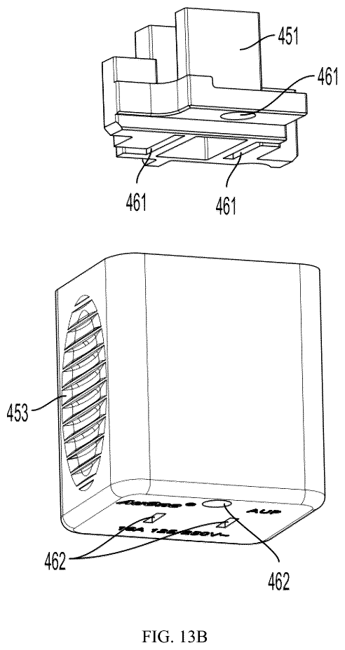

As illustrated in FIG. 11, FIG. 12A, FIG. 12B, and FIG. 13A, the overheat/overcurrent protection component can be wired in an alternative configuration from that discussed above. Lead end 312 is fixed on a first end of a main body such as main body 1, or main body 311 as shown in FIG. 11. Main body 311 can optionally comprise all the components of main body 1 discussed above including, for example, a shell, a positioning module, locking structures, pairing structures, and assembly structures. However, main body 311 can differ from main body 1 in dimension or shape, as needed. Lead end 312 comprises a live wire 321, a neutral wire 322, and, optionally, a ground wire 323.

A second end of the main body 311 is provided with a live wire pin 331 and a neutral wire pin 332. Live wire pin 331 can include a first live fin 335 and/or a second live fin 336. Neutral wire pin 332 can also include a first neutral fin 337 and/or a second neutral fin 338. Each first live fin 335, second live fin 336, first neutral fin 337, and/or second neutral fin 338, while optional, can each comprise a fin or other protrusion, such as a blade, tab, or strip, from live wire pin 331 or neutral wire pin 332. Each fin provides its associated pin increased surface area to establish physical, electrical, and/or thermal connections. Fins can perform functions like heat transmission or electrical/physical connection to other components. As an example, first live fin 335 can be riveted to overheat/overcurrent protection component 343, which is discussed below.

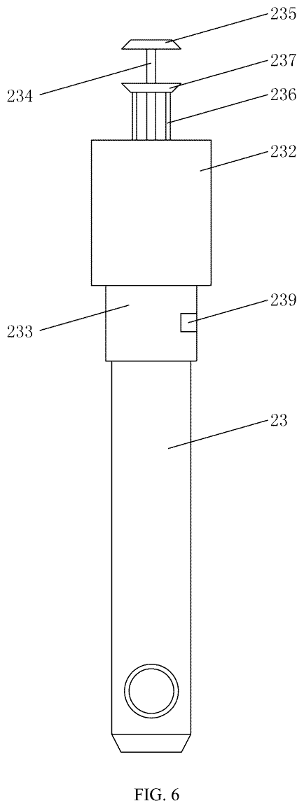

Optionally, main body 311 can be provided with a ground wire pin 333. Ground wire pin 333 can be fixedly connected to lead end 312, via an optional ground wire 323, or can be removably connected. Ground wire pin 333 can be provided with a quick replacement component which may be retained by first locking structures and second locking structures as described above and as shown in the above figures, including FIGS. 3 and 6. Live wire pin 331, neutral wire pin 332, and ground wire pin 333 can also comprise folding plates as discussed above. For example, first neutral fin 337 on neutral wire pin 332 can serve as a folding plate and ground wire pin 333 can incorporate a folding plate 315.

Overheat/overcurrent protection component 343 is positioned as shown in FIG. 12A and FIG. 12B. Overheat/overcurrent protection component 343 is an embodiment of the overheat/overcurrent protection component(s) shown in FIG. 1 to FIG. 2 and discussed above.

Overheat/overcurrent protection component 343 includes a connecting terminal 361, a fixed contact piece 362, and a bimetallic strip 363. The connecting terminal 361 is fixedly connected to the fixed contact piece 362 by at least one insulated terminal 364. The bimetallic strip 363 has a first end fixedly connected to the fixed contact piece 362. The bimetallic strip 363 has a second end provided with a moving contact 365, and a static contact 366 is arranged on the connecting terminal 361.

Live wire 321 at the lead end 312 is fixedly connected to a first surface 351 of the connecting terminal 361 of overheat/overcurrent protection component 343 by, for example, welding or riveting. Preferably but optionally, connecting terminal 361 comprises a fin or other protrusion, such as a blade, tab, or strip, for example, terminal fin 339 with first surface 351, where first surface 351 of connecting terminal 361 acts as the interface between overheat/overcurrent protection component 343 and the lead end 312 via live wire 321.

Live wire pin 331 can comprise a first live fin 335 fixedly connected to a third surface 353 of fixed contact piece 362, for example, by welding or riveting. Alternatively, live wire pin 331 can be fixedly connected directly to a third surface 353 of fixed contact piece 362 of overheat/overcurrent protection component 343, for example, by welding or riveting. Third surface 353 between live wire pin 331 and fixed contact piece 362 of overheat/overcurrent protection component 343 acts as an interface between overheat/overcurrent protection component 343 and live wire pin 331. Fixed contact piece 362 optionally comprises a fin or other protrusion, such as a blade, tab, or strip, for example, contact fin 340 on which third surface 353 can be positioned.

Live wire pin 331 can further comprise a second live fin 336 connected to a second surface 352 of overheat/overcurrent protection component 343. Second live fin 336 conducts heat from live wire pin 331 to the overheat/overcurrent protection component 343. Alternatively, live wire pin 331 can be connected directly to a second surface 352 of overheat/overcurrent protection component 343. Thus, live wire 321 of lead end 312 forms a series connection with live wire pin 331 (either directly or through fins) via overheat/overcurrent protection component 343. Further, heat at live wire pin 331 can be transmitted to overheat/overcurrent protection component 343 via second live fin 336 (or from the pin directly), and excess heat can cause the overheat/overcurrent protection component 343 to disconnect current flow as discussed.

First live fin 335 of live wire pin 331 can be connected to overheat/overcurrent protection component 343 by, for example, welding or riveting, with second live fin 336 in contact with fixed contact piece 362 of overheat/overcurrent protection component 343. Optionally, second live fin 336 can be fixedly connected with overheat/overcurrent protection component 343. First neutral fin 337 of neutral wire pin 332 can be connected to neutral wire 322 of lead end 312 by, for example, welding or riveting, with second neutral fin 338 in contact with heat conductor 344. Alternatively, neutral wire 332 of lead end 312 can be connected directly to neutral wire pin 332. Second neutral fin 338 can be connected, fixedly or removably, to heat conductor 344 while maintaining the thermal-conductivity and electrical isolation properties of the heat conductor 344.

Neutral wire 322 of lead end 312 is fixedly connected to neutral wire pin 332 at first neutral fin 337 by welding or riveting, while second neutral fin 338 of neutral wire pin 332 is thermally connected to overheat/overcurrent protection component 343 via heat conductor 344 at a fourth surface 354 of fixed contact piece 362. Optionally, neutral wire pin 332 can be directly thermally connected to overheat/overcurrent protection component 343 via heat conductor 344, without second neutral fin 338 as an intermediary.

Optional ground wire 323 of lead end 312 can be removably connected to optional ground wire pin 333, ground wire 323 of lead end 312 can be fixedly connected to optional ground wire pin 333 by welding or riveting or, alternatively, ground wire pin 333 can further comprise a quick replacement component, implemented in conjunction with a compatible main body as shown in FIGS. 3 and 6, and as described above.

Overheat/overcurrent protection component 343 can also be substituted with electronic temperature controllers or one-time thermal fuses.

Heat conductor 344 is an electrically-insulated thermal conductor comprised of a ceramic material, shaped as stacked, flat, rectangular portions. However, other shapes and other materials which are electrically-insulated yet thermally-conductive can also be selected. Heat conductor 344 can be sandwiched between second neutral fin 338 of neutral wire pin 332 and fixed contact piece 362 of overheat/overcurrent protection component 343, or sandwiched directly between neutral wire pin 332 and fixed contact piece 362. Heat conductor 344 allows transmission of heat from neutral wire pin 332 to overheat/overcurrent protection component 343, while electrically insulating neutral wire pin 332 from overheat/overcurrent protection component 343 and, in turn, live wire pin 331 and live wire 321 of lead end 312. This allows heat at neutral wire pin 332 to be transmitted to overheat/overcurrent protection component 343 directly, or via second neutral fin 338, and can allow overheat/overcurrent protection component 343 to disconnect current flow as discussed.

A PTC element 367 can be bridged between the connecting terminal 361 and the bimetallic strip 363. The PTC element 367 has a far greater value of resistance than the bimetallic strip 363. In normal conditions, the PTC element 367 and the bimetallic strip 363 are equivalent to being in parallel connection, and the PTC element 367 does not activate due to a very low division voltage, hence does not generate heat. When poor contact results in high temperature and short circuit, the bimetallic strip 363 trips to cut off the path between the moving contact 365 and the static contact 366, enabling the PTC element 367 to receive a working voltage, and the PTC element 367 generates heat to maintain the thermal deformation state of the bimetallic strip 363. Therefore, the plug main body 311 needs to power off to reduce the temperature of the PTC element 367 before it can be reused, thereby implementing a power-off reset function and avoiding power supply circuit trips caused by an electrical appliance restarting before electrical issues can be resolved.

Conversely, an automatic reset can be implemented to restore operation of the overheat/overcurrent protection component 343 once the high temperature condition has passed. For example, by excluding a PTC element which would otherwise generate heat to maintain the thermal deformation state of the bimetallic strip 363, the bimetallic strip 363 will return to its original shape and restore the path between the moving contact 365 and static contact 366 once the high temperature condition has passed.

The moving contact 365 can be welded onto the bimetallic strip 363 employing a molten material, or the static contact 366 can be welded onto the connecting terminal 361 employing a molten material. The molten material can achieve a fusing effect. When the overheat/overcurrent protection component has a failure, the molten material on the moving contact 365 or the static contact 366 can also fail, thereby causing the moving contact 365 and the static contact 366 to disengage and forcing the power off, protecting the socket, the electrical appliance, and the whole power supply circuit.

During operation, if an electrical overload or short circuit occurs on the circuit between an electrical appliance, the plug, and a socket, particularly when poor contact and the like occur between the plug and the socket, or when an electrical spark, temperature rise, or the like occur at the contact area between the plug and the socket during use of the electrical appliance, the bimetallic strip 363 can respond quickly and deform, cutting off the path between the moving contact 365 and the static contact 366, thereby disconnecting the current flow to protect the plug main body 311 and the socket.

If live wire pin 331 experiences high temperatures, the heat will be transmitted to overheat/overcurrent protection component 343 which will trip. The activated overheat/overcurrent protection component 343 will disconnect power between the lead end 312 and the live wire pin 331. This can reduce the heat at live wire pin 331 or prevent the heat from rising further.

Similarly, if the temperature at neutral wire pin 332 reaches a high heat/high temperature, the heat will be transmitted through heat conductor 344 and, in turn, to overheat/overcurrent protection component 343. Overheat/overcurrent protection component 343 will trip/activate and disconnect power between the lead end 312 and the live wire pin 331. This can reduce the heat at neutral wire pin 332 or prevent the heat from rising further. Overheat/overcurrent protection component 343 can trip and disconnect power at a predetermined heat or temperature which can be dependent upon, for example, the properties of the bimetallic strip 363 or molten material.

An alternative embodiment of a main body is shown in FIG. 13A and 13B. Frame 451 comprises plug holes 461 to accommodate live wire pin 441 and neutral wire pin 442, as well as optional ground wire pin 443. Housing 453 is a hollow structure with an upper opening and similarly comprises plug holes 462 on a lower surface to accommodate live wire pin 441 and neutral wire pin 442, as well as optional ground wire pin 443. Housing 453 is sized such that frame 451 and cover 452 seat within housing 453.

While cover 452 is shown as comprising two constituent components in FIG. 13A, cover 452 can comprise more than two constituent components, and fits within the upper opening of housing 453. Cover 452 defines an aperture 463 to accommodate a neck groove 412 on lead end 411. As shown, the constituent components can be arranged symmetrically and can be removably connected such that cover 452 defines aperture 463. Neck groove 412 is removably connected to cover 452 via aperture 463 and, once connected, fits within the upper opening of housing 453, such that lead end 411 is fixed with respect to cover 452 toward the upper end of housing 453. Frame 451, cover 452, and housing 453 can be composed of a non-electrically conductive materials such as plastic, ceramic, or a mixture of such materials.

Frame 451 comprises lower protrusions 465 and cover 452 comprises upper protrusions 464 which secure in place internal components, such as overheat/overcurrent protection component 433, heat conductor 434, live wire pin 441, neutral wire pin 442, and/or optional ground wire pin 443. As assembled, frame 451, cover 452, and housing 453 expose live wire pin 441, neutral wire pin 442, and optional ground wire pin 443 while securing in place components such as live wire 421 of lead end 411, neutral wire 422 of lead end 411, optional ground wire 423 of lead end 411, overheat/overcurrent protection component 433, heat conductor 434, live wire pin 441, neutral wire pin 442, and optional ground wire pin 443. Lead end 411 with live wire 421, neutral wire 422, and ground wire 423, as well as components including at least overheat/overcurrent protection component 433, heat conductor 434, live wire pin 441, neutral wire pin 442, ground wire pin 443, are embodiments of the components shown in FIGS. 11-12 and discussed above.

Frame 451, cover 452, and housing 453 can be assembled by snap-fitting or removeable fasteners such as the screws 466 illustrated in FIG. 13A, bolts or other fasteners, thereby allowing quick assembly. Cover 452 and housing 453 can include bore holes as shown in FIG. 13A, such as horizontal bore holes 467, vertical bore holes 468, and housing bore holes 469 for receiving fasteners such as the screws 466 illustrated in FIG. 13A, bolts or other fasteners to facilitate assembly.

The above are merely preferred embodiments of the present disclosure. Any equivalent changes or modifications made according to the construction, features, and principles within the patent scope of the present disclosure are intended to be included within the patent scope of the present disclosure.

1. A plug with a temperature-controlled circuit breaker, comprising:
a main body;
a lead end;
a first pin; and
a second pin;
wherein the lead end is fixed on a first end of the main body,
wherein the first pin and the second pin are provided on a second end of the main body,
wherein an overheat/overcurrent protection component is connected in series between the lead end and the first pin, and
wherein the second pin is connected to the lead end, and wherein the second pin is thermally connected to, and electrically insulated from, the overheat/overcurrent protection component.

2. The plug with temperature-controlled circuit breaker according to claim 1, wherein the overheat/overcurrent protection component comprises:
a connecting terminal;
a fixed contact piece;
a bimetallic strip;
wherein the connecting terminal is fixedly connected to the fixed contact piece by an insulated terminal, and a static contact is arranged on the connecting terminal,
wherein the bimetallic strip has a first end fixedly connected to the fixed contact piece and the bimetallic strip has a second end provided with a moving contact, and
wherein the first pin is fixedly connected to the fixed contact piece and the lead end is connected to the connecting terminal of the overheat/overcurrent component.

3. The plug with temperature-controlled circuit breaker according to claim 1, wherein the second pin and the overheat/overcurrent protection component sandwich a heat conductor, which thermally connects, and electrically isolates, the second pin and the overheat/overcurrent protection component, and wherein the heat conductor is an electrically-insulated, thermal conductor comprising a ceramic material.

4. The plug with temperature-controlled circuit breaker according to claim 1, wherein the second pin comprises a fin, and wherein the heat conductor is sandwiched between the fin of the second pin and the overheat/overcurrent protection component.

5. The plug with temperature-controlled circuit breaker according to claim 2, wherein a positive temperature coefficient (“PTC”) element bridges the connecting terminal and the bimetallic strip.

6. The plug with temperature-controlled circuit breaker according to claim 2, wherein the moving contact is welded onto the bimetallic strip with a molten material, or the static contact is welded onto the connecting terminal with a molten material.

7. The plug with temperature-controlled circuit breaker according to claim 1, wherein the main body is further provided with a ground wire pin, and wherein the ground wire pin is electrically connected to the lead end.

8. The plug with temperature-controlled circuit breaker according to claim 1, wherein one or both of the first pin or the second pin comprises at least one fin, wherein the at least one fin provides increased surface area for one or more of physical, electrical, or thermal connection.

9. The plug with temperature-controlled circuit breaker according to claim 1, wherein the first pin is a live wire pin and the second pin is a neutral wire pin.

10. The plug with temperature-controlled circuit breaker according to claim 1, wherein the overheat/overcurrent protection component disconnects the first lead end and the first pin when either the first pin or the second pin reaches a predetermined temperature.

11. The plug with temperature-controlled circuit breaker according to claim 1, wherein the main body further comprises:
a housing;
wherein the housing is a hollow structure with an upper opening and plug holes on a lower surface, wherein located within the housing is a cover comprising upper protrusions and two constituent components which are arranged symmetrically, and are removably connected to each other to form an aperture, and wherein located within the housing is a frame comprising lower protrusions and plug holes,
wherein the lead end comprises a neck groove,
wherein the neck groove is removably connected to the aperture such that the lead end is removably connected to the upper opening of the housing, and
wherein the first pin and second pin insert through the plug holes of the frame and the housing.

12. The plug with temperature-controlled circuit breaker according to claim 11, wherein the main body is further provided with a ground wire pin, wherein the ground wire pin is electrically connected to the lead end, and wherein the ground wire pin inserts through the plug holes of the frame and the housing.

13. The plug with temperature-controlled circuit breaker according to claim 1, wherein the overheat/overcurrent protection component comprises an automatic reset.

14. A plug with a temperature-controlled circuit breaker comprising:
a main body;
a lead end comprising a neck groove;
a live wire pin;
a neutral wire pin;
an overcurrent/overheat protection component;
wherein the overheat/overcurrent protection component is connected in series between the lead end and the live wire pin, wherein the neutral wire pin is thermally connected to, but electrically insulated from, the overheat/overcurrent protection component, and wherein the lead end is connected to the neutral wire pin.

15. The plug with temperature-controlled circuit breaker of claim 14, wherein the overheat/overcurrent protection component is connected in series between the lead end and the live wire pin at a first live fin and a second live fin, wherein the lead end is connected to the neutral wire pin at a first neutral fin, and wherein a second neutral fin of the neutral wire pin is thermally connected to, but electrically insulated from, the overheat/overcurrent protection component.

16. The plug with temperature-controlled circuit breaker of claim 14, further comprising a shell and a positioning module, wherein the positioning module comprises at least two constituent components combined by removeable connection, and comprises a plurality of limit blocks.

17. The plug with temperature-controlled circuit breaker of claim 14, further comprising a shell, wherein the shell comprises plug holes on a lower end surface of the shell, and wherein the live wire pin and the neutral wire pin insert through the plug holes of the shell.

18. The plug with temperature-controlled circuit breaker of claim 14, further comprising a shell and a positioning module, wherein the shell is a hollow structure with an upper opening, wherein the positioning module defines a positioning opening, and the positioning module fits within the upper opening of the shell, wherein the neck groove is removably connected to the positioning opening of the positioning module such that the lead end is removably connected to the upper opening of the shell.

19. The plug with temperature-controlled circuit breaker according to claim 14, further comprising:
a shell;
a positioning module;
a ground wire pin;
a first locking structure;
a second locking structure;
an assistant pairing structure; and
an assistant assembly structure;
wherein the ground wire pin is provided on a second end of the main body, and wherein the lead end is connected to the ground wire pin,
wherein the first locking structure and the second locking structure retain the ground wire pin,
wherein the first locking structure and the second locking structure release the ground wire pin when the ground wire pin is rotated and slid upward,
wherein the assistant pairing structure couples the positioning module with the lead end,
wherein the assistant pairing structure releases the positioning module from the lead end when a tool is applied,
wherein the assistant assembly structure couples the positioning module with the shell, and
wherein the assistant assembly structure releases the positioning module from the shell when a sufficiently large vertical force is applied to the positioning module or the shell.

20. A plug with a temperature-controlled circuit breaker, comprising:
a main body;
a lead end;
a live wire pin; and
a neutral wire pin;
wherein the lead end is fixed on a first end of the main body,
wherein the live wire pin and the neutral wire pin are provided on a second end of the main body,
wherein the live wire pin comprises a first live fin and a second live fin,
wherein the neutral wire pin comprises a first neutral fin and a second neutral fin,
wherein an overheat/overcurrent protection component is connected in series between the lead end and the live wire pin via the first live fin,
wherein the second live fin is thermally connected to the overheat/overcurrent protection component,
wherein the first neutral fin is connected to the lead end, and
wherein the second neutral fin is thermally connected to, and electrically insulated from, the overheat/overcurrent protection component.
